(19) United States
(12) Patent Application Publication
(10) Pub. No.: US 2023/0219686 A1
(43) Pub. Date: Jul. 13, 2023

(54) VERTICAL TAKEOFF AND LANDING TANDEM WING AIRCRAFT THAT IS PROPELLED BY A SYSTEM OF ELECTRIC DUCTED FANS

(71) Applicant: RODRIGO DANIEL ZELAYETA, LOMAS DE ZAMORA (AR)

(72) Inventor: RODRIGO DANIEL ZELAYETA, LOMAS DE ZAMORA (AR)

(21) Appl. No.: 17/573,521

(22) Filed: Jan. 11, 2022

(51) Int. Cl. B64C 29/00; B64C 39/08; B64C 3/14

(52) U.S. Cl. CPC B64C 29/0033; B64C 39/08; B64C 29/0025; B64C 3/14

(57) ABSTRACT

A tandem wing aircraft that uses electric ducted fans to propel itself. The positioning of the electrical ducted fans allows the aircraft to take off and land vertically when the electrical ducted fans have their airflow outlet in a vertical position and to fly horizontally when a pair of electrical ducted fans are rotated so that their airflow outlet are in a horizontal position. The tandem wing aircraft uses an electric power source to power the aircraft and is controlled by a logic and electronic controller. The aircraft uses flaps, vertical stabilizers, ailerons, and an elevator to control its orientation and position during horizontal flight. The aircraft is designed to fly in urban spaces because of its wing and propulsion design. In addition, this design guarantees the stability of the aircraft on all flight stages, as well as the emergency landing in case the electrical ducted fans fail.

### BACKGROUND

The present invention pertains to a vertical takeoff and landing tandem wing aircraft that is propelled by a system of electric ducted fans.

The tandem wing aircraft uses a Prandtl wing configuration. The aircraft is designed to be a short take-off and landing aircraft.

The aircraft, in its preferred embodiment, is to be a lithium or hydrogen powered aircraft.

The aircraft is designed to be flown in urban areas and is to be used to fly passengers as well as cargo.

The aircraft control system will allow it to fly manned as well as unmanned.

The present invention provides vertical takeoff and landing tandem wing aircraft that is propelled by a system of electric ducted fans that can be used to provide transport in urban areas because of the aircraft's ability to vertically takeoff and landing, as well as to efficiently move in horizontal directions.

### SUMMARY

The present invention is directed to a vertical takeoff and landing tandem wing aircraft that is propelled by a system of electric ducted fans that can be used in urban areas.

A tandem wing aircraft that uses electric ducted fans to propel itself The positioning of the electric ducted fans in relation to the center of gravity of the aircraft allows it to takeoff and land vertically through its thrust and the moments generated when all its electric ducted fans have their airflow outlet in a vertical position and allows it to fly horizontally when the pair of electric ducted fans at the ends of the front fixed wing are rotated so that their airflow outlet are in a horizontal position, generating the lift of the aircraft surfaces when it takes velocity with its horizontal thrust and thus avoid using the rest of the electric ducted fans, saving energy. The tandem wing aircraft uses an electric power source to power the aircraft and is controlled by a logical and electronic controller. The aircraft uses flaps, vertical stabilizers, ailerons, rudders and an elevator to control its orientation during horizontal flight. The selection of the aerodynamic profiles of the wings and fuselage, the configuration of the wings, that is, number of wings, the surface, geometric shape, separation distance between them and angle of incidence of each one, allows to lift the aircraft weight and let it fly at the equilibrium design point, with longitudinal, transverse and vertical static and dynamic stability.

An object of the present invention is to provide an aircraft that can vertically takeoff and land.

Another object of the present invention is to provide an aircraft that efficiently transition into horizontal flight after taking off vertically and then transition from horizontal flight into vertical flight to it can land.

Yet another object of the present invention is to provide an aircraft that can be used in urban areas.

Yet still another object of the present invention is to provide an aircraft that is powered by a system of electrically ducted fans.

A further object of the present invention is to provide an aircraft that electrically powered.

Yet a further object of the present invention is to provide an aircraft that can safely land through its commands and aerodynamic design if a power malfunction occurs or breakage of a part in the aircraft's electric ducted fans.

Yet still a further object of the present invention is to provide an aircraft that can fly stably.

### DRAWINGS

These and other features, aspects, and advantages of the present invention will become better understood with regards to the following description, appended claims, and drawings where:

FIG. 1 is a top plan view of the present invention;

FIG. 2 is a top plan view of the present invention that describes the airfoils of the present invention;

FIG. 3 is a perspective view of the present invention;

FIG. 4 is a diagram that shows the fuselage and the elements within the fuselage;

FIG. 5 is a side view of the present invention that shows the electric ducted fans in a position that will allow the aircraft to takeoff and land in a vertical manner;

FIG. 6 is a side view of the present invention that shows the left and the right tiltrotors of the present invention moving the left and the right electric ducted fans into a position that will allow the aircraft to begin the transition from hover flight to horizontal flight;

FIG. 7 is a side view of the present invention that shows the left and the right electric ducted fans in a position that will allow the aircraft to fly horizontally;

FIG. 8 is a top plan view of the present invention that shows how the spin of the electric ducted fans to control the angular moment in all stages of flight;

FIG. 9 is a perspective view that describer the NACA airfoil codes of the front and rear wings, fuselage and vertical stabilizers of the present invention; and

FIG. 10 is a front view of the present invention that shows the dihedral angle of the front and rear wings.

### DESCRIPTION

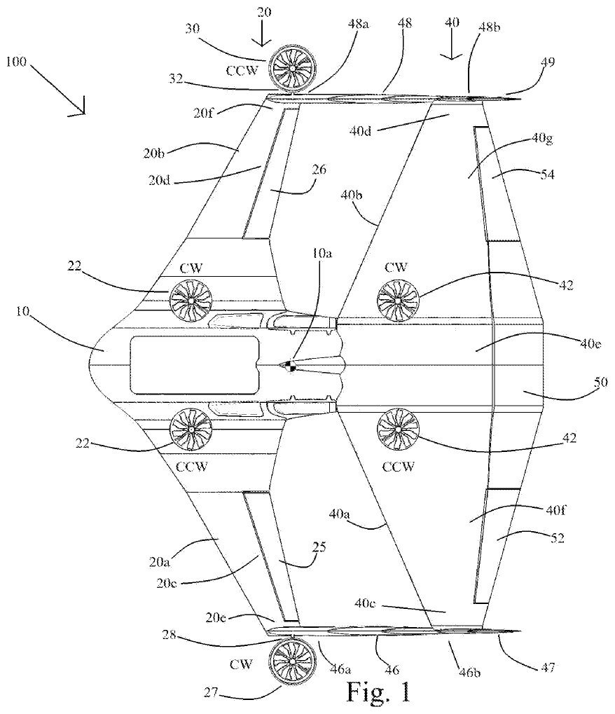

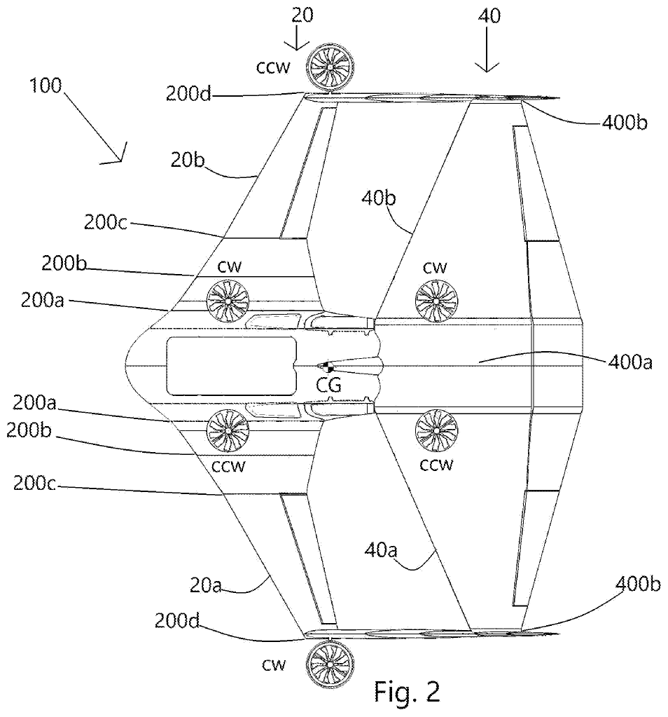

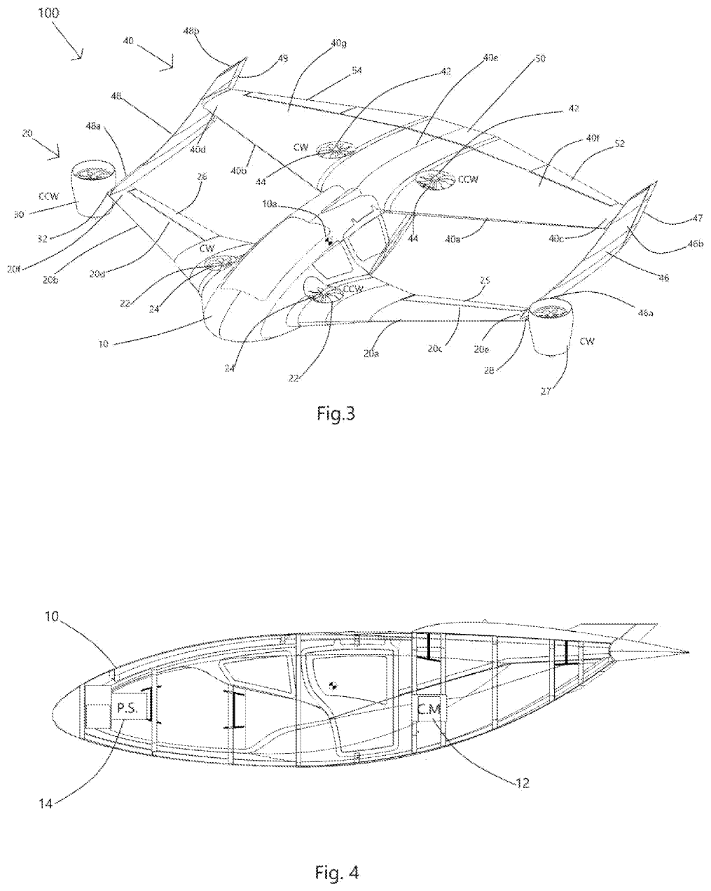

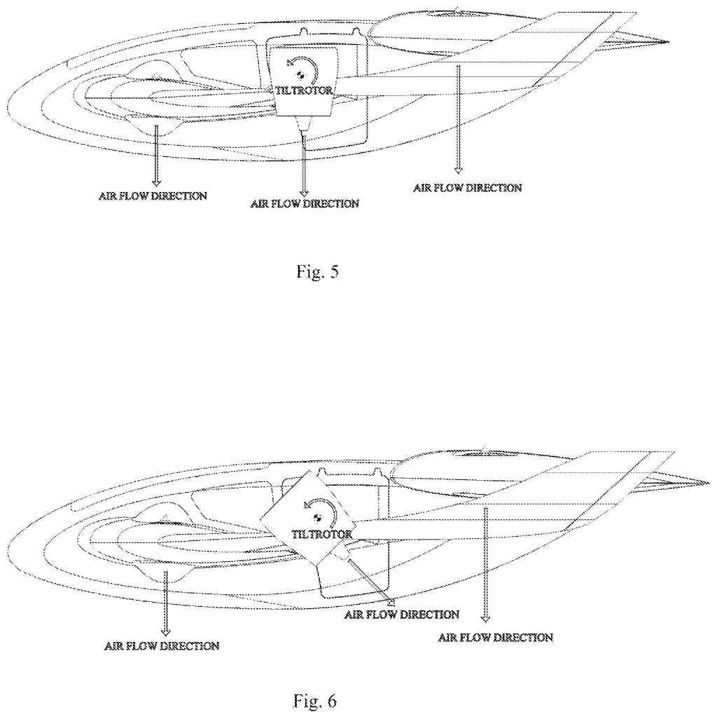

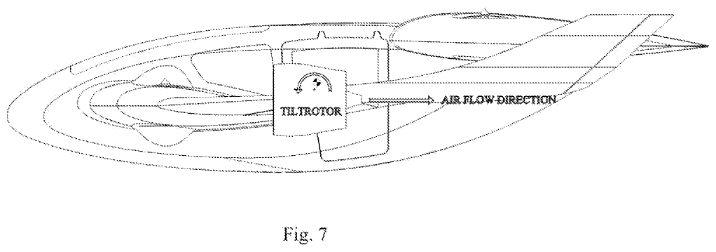

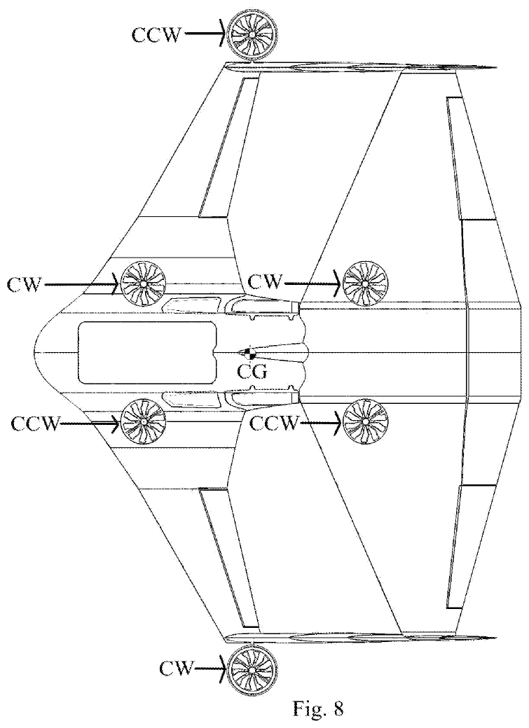

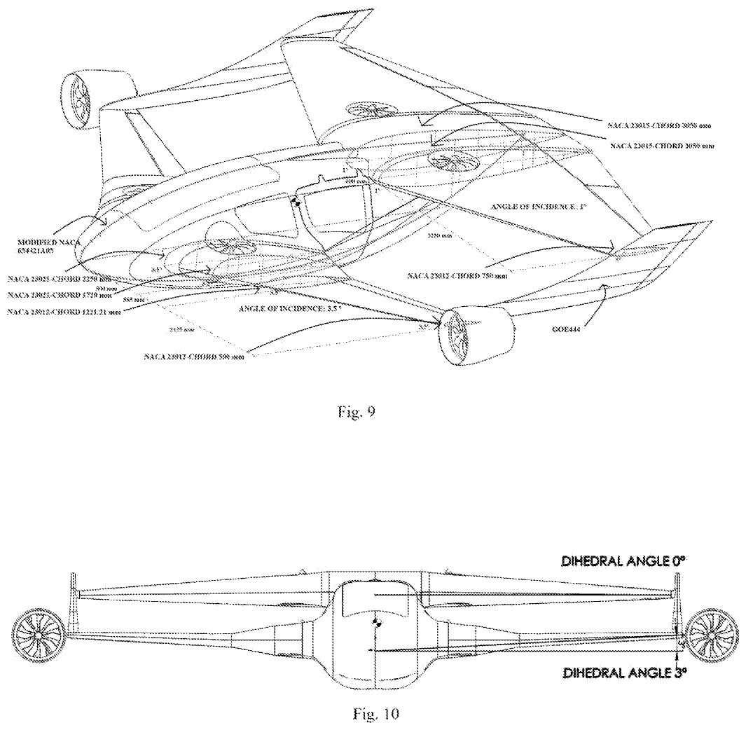

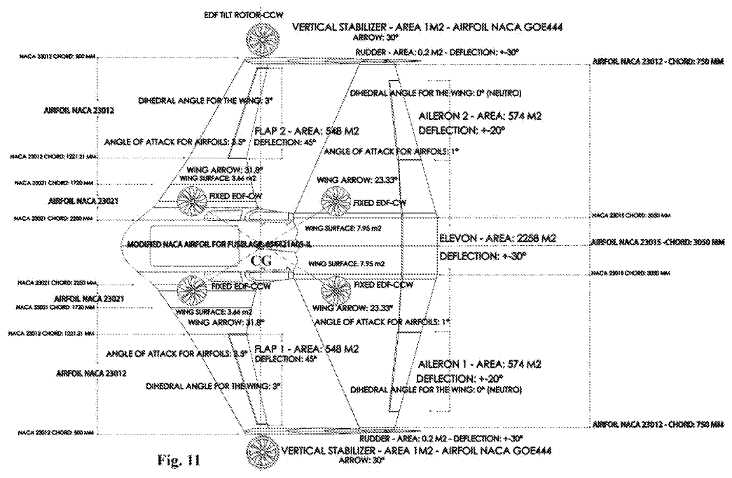

Referring to FIGS. 1-10, the present invention is a vertical takeoff and landing tandem wing aircraft 100 that is propelled by a system of electric ducted fans.

The aircraft 100 comprises of a fuselage 10 that defines a center of gravity 10a, the fuselage 10 houses a control module 12 and a power source 14, the control module 12 and the power source 14 are configured to control and power the movable elements of the aircraft. A front wing 20 that defines a left 20a and a right side 20b, each side 20a, 20b of the front wing 20 defines an embedded front wing electric ducted fan 22, each front wing electric ducted fan 22 defines a front wing airflow outlet 24 and each front wing airflow outlet 24 is perpendicular to the longitudinal and transverse axis of the aircraft 100, the electric ducted fans 22 are configured to operate when the aircraft 100 takes off and lands vertically, the front wing 20 has an angle of incidence of 3.5 degree and an angle of dihedral of 3.0 degree. A left flap 25 is attached to a rear left side section 20c of the front wing 20 and a right flap 26 is attached to a rear right section 20d of the front wing 20. A left electric ducted fan 27 is attached to a left tiltrotor 28, the left tiltrotor 28 is attached to an end 20e of the left side 20a of the front wing 20 so that left electric ducted fan 27 is configured to rotate on a physical axis that is parallel to the transverse axis of the aircraft 100, the left electric ducted fan 27 is configured to operate when the aircraft 100 takes off and lands vertically as well as during horizontal flight. A right electric ducted fan 30 is attached to a right tiltrotor 32, the right tiltrotor 32 is attached to an end 20f of the right side 20b of the front wing 20 so that right electric ducted fan 30 is configured to rotate on a physical axis that is parallel to the transverse axis of the aircraft 100, the right electric ducted fan 30 is configured to operate when the aircraft 100 takes off and lands vertically as well as during horizontal flight. A rear wing 40 that defines a left side 40a and a right side 40b, each side 40a, 40b of the rear wing 40 defines an embedded rear wing electric ducted fan 42, each rear wing electric ducted fan 42 defines a rear wing airflow outlet 44 and each rear wing airflow outlet 44 is perpendicular to the longitudinal and transverse axis of the aircraft 100, the electric ducted fan 42 is configured only to operate when the aircraft 100 takes off and lands vertically the rear wing 40 has an angle of incidence of 1.0 degree and a neutral angle of dihedral. A left vertical stabilizer 46 attaches to an end 40c of the left side 40a of the rear wing 40 and the left vertical stabilizer 46 defines a left vertical stabilizer section 46a that attaches to the end 20e of the left side 20a of the front wing 20, a left rudder 47 attaches to a rear section 46b of the left vertical stabilizer 46. A right vertical stabilizer 48 attaches to an end 40d of the right side 40b of the rear wing 40 and the right vertical stabilizer 48 defines a right vertical stabilizer section 48a that attaches to the end 20f of the right side 20b of the front wing 20, a right rudder 49 attaches to a rear section 48b of the right vertical stabilizer 48. An elevator 50 that is attached to a central rear section 40e of the rear wing 40 and the elevator 50 is centered on the longitudinal axis of the aircraft 100. And a left aileron 52 that attaches to a rear left section 40f of the rear wing 40 and a right aileron 54 that attaches to a rear right section 40g of the rear wing 40.

In a preferred embodiment of the present invention, the fuselage 10 is a modified NACA 654421A05 airfoil.

In a preferred embodiment of the present invention, the left vertical stabilizer 46 and the right vertical stabilizer 48 are a GOE 444 airfoil.

In a preferred embodiment of the present invention, the front wing 20 is an airfoil that is a NACA 23021 airfoil with a chord length of 2250 mm at a wing root area 200a of the left side 20a and the right side 20b of the front wing 20 is a NACA 23021 airfoil with a chord length of 1720 mm at a middle area 200b of the left side 20a and the right side 20b of the front wing 20, a NACA 23012 airfoil with a chord length of 1221 mm at a middle area 200c of the left side 20a and the right side 20b of the front wing 20, and a NACA 23012 airfoil with a chord length of 500 mm at wing tip area 200c of the left side 20a and the right side 20b of the front wing 20.

In a preferred embodiment of the present invention, the rear wing 40 is a NACA 23015 airfoil with a chord length of 3050 mm at a middle area 400a of the rear wing 40 and a NACA 23012 airfoil with a chord length of 750 mm at a wing tip area 400b of the left side 40a and the right side 40b of the rear wing 40.

In an embodiment of the present invention, all the electric ducted fans 22, 22, 27, 30, 42 and 42 are configured to work simultaneously when the aircrafts 100 takes-off or lands.

In an embodiment of the present invention, the electric ducted fans 22, 42 on the left side 20a, 40a of the front wing 20 and the rear wing 40 are configured to spin in the same direction as the right electric ducted 30 fan that is attached to the right tiltrotor 32 when the aircraft takes-off and lands, and the electric ducted fans 22, 42 on the right side 20b, 40b of the front wing 20 and the rear wing 40 are configured to spin in the same direction as the left electric ducted fan 27 that is attached to the left tiltrotor 28 when the aircraft 100 takes-off and lands.

In an embodiment of the present invention, the fuselage 10, the front wing 20 and the rear wing 40, all the electric ducted fans 22, 42, the left tiltrotor 28 and the right tiltrotor 32, the left flap 25 and the right flap 26, the left vertical stabilizer 46 and the right vertical stabilizer 48, the elevator 50, and the left aileron 52 and the right aileron 54 are made of a carbon fiber composite material.

In an embodiment of the present invention, the energy source 14 for the operation of all the electrical components of the aircraft is a lithium battery distributed in several individual modules that together in series will form a single battery with the necessary power.

In another embodiment of the present invention, the power source 14 is a hydrogen battery.

In yet another embodiment of the present invention, the energy source 14 is a generator, which uses renewable sources and fossil fuel to generate energy.

An advantage of the present invention is that it provides an aircraft that can vertically takeoff and land. To achieve this, the following design decisions were made: The aircraft has a total of 6 EDFs (Electric ducted Fans) that must all work together at the time of vertical takeoff and landing to achieve the necessary thrust to lift the weight of the aircraft in a balanced way.

Another advantage of the present invention is that it provides an aircraft that can efficiently transition into horizontal flight after taking off vertically and then transition from horizontal flight to vertical flight to land. Once the aircraft takes off vertically, it is suspended in hover flight and begins progressively rotating its tiltrotors, it will gradually take speed in horizontal flight, beginning to generate lift mainly through its wings until it gets the stall speed and generates enough lift to get balance the aircraft weight caused by gravity. After this, the TILTROTORs will remain horizontal to generate only the thrust necessary for horizontal cruise flight and then the remaining 4 EDFs that are embedded in both wings (front wing and rear wing) will stop working, optimizing energy resources. To land it will perform the same sequence, but in an inverted way.

Yet another advantage of the present invention is that it provides an aircraft that can be used in urban areas. A tandem wing configuration, also known as the Prandtl configuration, was chosen for the aircraft with the intention of having sufficient wing area to generate the required lift in horizontal flight with a smaller wingspan, so that the aircraft model has ease of maneuver in confined urban spaces and also to aerodynamically locate, fix and mask the 4 fixed EDFs embedded in the wings to reduce the drag caused by them, when they are not used in horizontal flight.

Yet still another advantage of the present invention is that it provides an aircraft that is powered by a system of electrically ducted fans. The 6 electric ducted fans are located at precise distances from the aircraft's center of gravity so that when they are all working together with the same thrust in vertical flight, they generate moments so that the aircraft remains balanced in its center of gravity. The configuration of the aircraft electric ducted fans has 3 interspersed motors with its corresponding blades turning counterclockwise (CCW) with the other 3 rotating clockwise with its corresponding blades (CW). With this configuration of motors and blades to rotate in opposite direction, the total angular momentum is zero.

A further advantage of the present invention is that it provides an aircraft that is powered by electrical power.

Yet a further advantage of the present invention is that it provides an aircraft that can safely land only with the flight controls functioning if a power malfunction occurs in the aircraft propulsion systems. In the event of catastrophic failure, when all the motors or part of them do not work, the aircraft is designed to land horizontally, gliding, this is one of the design considerations. Apart, the aircraft being able to have a short take-off and landing with lower power consumption, optimizing its autonomy, when the conditions required to achieve it are met.

Yet still a further advantage of the present invention is that it provides an aircraft that can fly stably. The longitudinal static stability is achieved by selection of the aerodynamic profiles of the wings and fuselage, the configuration of the wings, that is, the surface, geometric shape, separation distance between them and angle of incidence of each one, which is 3.5° to the front wing and i° to the rear wing, allows it fly at the design point of equilibrium. To ensure lateral static stability, only the front wing of the plane has a 3° angle of dihedral, keeping a neutral dihedral for the rear wing. The static directional stability is achieved by two vertical stabilizers mounted at the ends of the front and rear wings, forming an H configuration that allows obtaining the necessary qualities of directional stability together with the required directional control. In addition, two additional vertical surfaces are placed that create a union between the vertical stabilizers and the front wing that ensure structural resistance against the vector thrust of the rotating electric ducted fans at the ends of the front wings. The design criteria used to obtain the geometry of the vertical stabilizers and rudders are that the surfaces can generate such force as to compensate for the loss of a motor in cruise flight and maintain balance. The deflection of each rudder for this condition is approximately 20°, being the maximum possible deflection at least 30°. In addition, these surfaces enhance the directional stability qualities of the aircraft. The data for each vertical stabilizer, not including the joint surface, are:
Root chord=1 m
Tip chord=1 m
Leading edge arrow=30°
Wingspan=1 m
Area=1 m2
The data of each rudder:
Rudder chord=20% of vertical stabilizer chord
Wingspan=1 m
Rudder Area=0,2 m2
Design deflection=±20°
Maximum deflection (at least)=±30°

The embodiments of the vertical takeoff and landing tandem wing aircraft that is propelled by a system of electric ducted fans described herein are exemplary and numerous modifications, combinations, variations, and rearrangements can be readily envisioned to achieve an equivalent result, all of which are intended to be embraced within the scope of the appended claims. Further, nothing in the above-provided discussions of the vertical takeoff and landing tandem wing aircraft that is propelled by a system of electric ducted fan should be construed as limiting the invention to an embodiment or a combination of embodiments. The scope of the invention is defined by the description, drawings, and appended claims.

What is claimed is:

1. A tandem wing aircraft that is propelled by electric ducted fans, the aircraft comprises of:
a fuselage that defines a center of gravity, the fuselage houses a control module and a power source, the control module and the power source are configured to control and power all the movable elements of the aircraft;
a front wing that defines a left and a right side, each side of the front wing defines an embedded front wing electric ducted fan, each front wing electric ducted fan defines a front wing airflow outlet and each front wing airflow outlet is perpendicular to the longitudinal and transverse axis of the aircraft, the front wing has an angle of incidence of 3.5 degree and an angle of dihedral of 3.0 degree;
a left flap is attached to a rear left side section of the front wing and a right flap is attached to a rear right section of the front wing;
a left electric ducted fan is attached to a left tiltrotor, the left tiltrotor is attached to an end of the left side of the front wing so that left electric ducted fan is configured to rotate on a physical axis that is parallel to the transverse axis of the aircraft, the left electric ducted fan is configured to operate when the aircraft is taking off or landing vertically as well as during horizontal flight;
a right electric ducted fan is attached to a right tiltrotor, the right tiltrotor is attached to an end of the right side of the front wing so that right electric ducted fan is configured to rotate on a physical axis that is parallel to the transverse axis of the aircraft, the right electric ducted fan is configured to operate when the aircraft is taking off or landing vertically as well as during horizontal flight;
a rear wing that defines a left side and a right side, each side of the rear wing defines an embedded rear wing electric ducted fan, each rear wing electric ducted fan defines a rear wing airflow outlet and each rear wing airflow outlet is perpendicular to the longitudinal and transverse axis of the aircraft, the rear wing has an angle of incidence of 1.0 degree and a neutral angle of dihedral;
a left vertical stabilizer attaches to an end of the left side of the rear wing and the left vertical stabilizer defines a left vertical stabilizer section that attaches to the end of the left side of the front wing, a left rudder attaches to a rear section of the left vertical stabilizer;
a right vertical stabilizer attaches to an end of the right side of the rear wing and the right vertical stabilizer defines a right vertical stabilizer section that attaches to the end of the right side of the front wing, a right rudder attaches to a rear section of the right vertical stabilizer;
an elevator that is attached to a central rear section of the rear wing and the elevator is centered on the longitudinal axis of the aircraft; and
a left aileron that attaches to a rear left section of the rear wing and a right aileron that attaches to a rear right section of the rear wing.

2. The tandem wing aircraft that is propelled by electric ducted fans of claim 1, wherein the fuselage is a NACA 654421A05 airfoil.

3. The tandem wing aircraft that is propelled by electric ducted fans of claim 2, wherein the left vertical stabilizer and the right vertical stabilizer are a GOE 444 airfoil.

4. The tandem wing aircraft that is propelled by electric ducted fans of claim 3, wherein the front wing is an airfoil that is a NACA 23021 airfoil with a chord length of 2250 mm at a wing root area of the left side and the right side of the front wing, a NACA 23012 airfoil with a chord length of 1221 mm at a middle area of the left side and the right side of the front wing, and a NACA 23012 airfoil with a chord length of 500 mm at an end area of the left side and the right side of the front wing.

5. The tandem wing aircraft that is propelled by electric ducted fans of claim 4, wherein the rear wing is a NACA 23015 airfoil with a chord length of 3050 mm at a middle area of the rear wing and a NACA 23012 airfoil with a chord length of 750 mm at an outward area of the left side and the right side of the rear wing.

6. The tandem wing aircraft that is propelled by electric ducted fans of claim 1, wherein two of the electric ducted fans, which are located at the ends of the front wing have a triple purpose:
a first purpose is to take off and land, for this scenario the electric ducted fans are positioned perpendicular to the longitudinal and transverse axis of the aircraft. in this case all electric ducted fans work together;
a second purpose is that the electric ducted fans will modify your angle progressively, for transition from vertical flight to horizontal flight and vice a versa; and
a third purpose is to push it horizontally after the transition from vertical to horizontal flight, for this purpose the electric ducted fans are positioned parallel to the longitudinal and transverse axis of the aircraft.

7. The tandem wing aircraft that is propelled by electric ducted fans of claim 1, wherein all the electric ducted fans are configured to work simultaneously when the aircrafts takes-off or lands, these electric duct fans generate a thrust in the opposite direction to gravity, allowing hover flight, to then be able to make the transition from vertical flight to horizontal flight.

8. The tandem wing aircraft that is propelled by electric ducted fans of claim 7, wherein the electric ducted fans on the left side of the front wing and the rear wing are configured to spin in the same direction as the electric ducted fan that is attached to the right tiltrotor when the aircraft takes-off and lands, and the electric ducted fans on the right side of the front wing and the rear wing are configured to spin in the same direction as the electric ducted fan that is attached to the left tiltrotor when the aircraft takes-off and lands.

9. The tandem wing aircraft that is propelled by electric ducted fans of claim 1, wherein the fuselage, the front wing and the rear wing, all the electric ducted fans, the left tiltrotor and the right tiltrotor, the left flap and the right flap, the left vertical stabilizer and the right vertical stabilizer, the elevator, the left aileron and the right aileron, the left rudder and the right rudder are made of a carbon fiber composite material.

10. The tandem wing aircraft that is propelled by electric ducted fans of claim 1, wherein the power source is a lithium rechargeable battery bank.

11. The tandem wing aircraft that is propelled by electric ducted fans of claim 1, wherein the power source is a hydrogen battery.

12. The tandem wing aircraft that is propelled by electric ducted fans of claim 1, wherein the power source is a generator, which uses renewable sources and fossil fuel to generate energy.
